(19) United States
(12) Patent Application Publication
(10) Pub. No.: US 2026/0259570 A1
(43) Pub. Date: Sep. 3, 2026

(54) METHOD FOR CONTROLLING MOVABLE MACHINE AND ASSOCIATED MACHINE FOR IMPLEMENTING THE SAME

(71) Applicant: ABB SCHWEIZ AG, Baden (CH)

(72) Inventors: JunJie Zhu, Shanghai (CN); Lei Qiu, Shanghai (CN); Zhijun Ding, Shanghai (CN); Yingyan Lin, Shanghai (CN); Zhenghao Dong, Shanghai (CN)

(21) Appl. No.: 19/651,147

(22) Filed: Apr. 17, 2026

Related U.S. Application Data
(63) Continuation of application No. PCT/CN2023/130846, filed on Nov. 9, 2023.

(51) Int. Cl. G05D 1/667; G05D 1/245; G05D 105/28

(52) U.S. Cl. CPC G05D 1/667; G05D 1/245; G05D 2105/28

(57) ABSTRACT

Embodiments of the present disclosure relate to a method for controlling a movable machine including a main body and a rotatable support platform mounted on the main body to receive a payload the method includes detecting an angular information of the main body and inversely rotating the support platform with respect to the main body based on the detected angular information.

### FIELD OF THE INVENTION

This invention relates to the robot technique, and more particularly, relates to a method for controlling movable machine and an associated movable machine for implementing the same.

### BACKGROUND OF THE INVENTION

Movable machines such as autonomous mobile robots (AMRs) or autonomous guided vehicles (AGV) are widely utilized in logistics, transportation and robotic automations. Cycle time and efficiency are of great importance in above utilization. Carrying a payload to its destination within shortest time, consuming least amount of energy, easier adaptation to conditions and layouts on factory floor or warehouse of different sizes and changing environment are increasingly important to users.

### SUMMARY OF THE INVENTION

The invention is defined by the claims.

According to one aspect of the disclosure, there is provided a method for controlling a movable machine comprising a main body and a rotatable support platform mounted on the main body to receive a payload, the method comprising: detecting an angular information of the main body; and inversely rotating the support platform with respect to the main body based on the detected angular information.

With the above method for controlling a movable machine, those skilled in the art will appreciate that the support platform as well as the payload placed thereon may then be controlled to not rotate with the main body of the movable machine. In this way, in the case that the movable machine is moving along a curved path, the rotational inertial of the payload needs not to be overcome, which may lower the driving torque for the movable machine and improve the time and/or energy efficiency.

In some embodiments, the inversely rotating the support platform with respect to the main body based on the detected angular information may comprise: inversely rotating the support platform with respect to the main body by a degree equal to a rotation degree of the main body derived from the detected angular information.

In some embodiments, the inversely rotating the support platform with respect to the main body based on the detected angular information may comprise: inversely rotating the support platform with respect to the main body during the movement of the movable machine along a curved path such that an orientation of the support platform is kept constant with respect to a ground where the movable machine is moving.

In some embodiments, the step of inversely rotating the support platform with respect to the main body may be performed in real time while the movable machine is moving along a path.

In some embodiments, the inversely rotating the support platform with respect to the main body based on the detected angular information may comprise: measuring a weight of the payload; and inversely rotating the support platform with respect to the main body based on the detected angular information and the measured weight of the payload.

In some embodiments, the angular information of the main body comprises an angular rate and a rotation direction.

In some embodiments, the detection of the angular information of the main body is performed by an Inertial Measurement Unit (IMU) integrated on the main body.

In some embodiments, wherein the detection of the angular information of the main body is performed by: measuring a rotation speed difference between two driving wheels arranged at the opposite sides of the main body; and calculating the angular information of the main body based on the measured rotation speed difference.

In some embodiments, the movable machine may comprise: an autonomous mobile robot (AMR) or an autonomous guided vehicles (AGV).

According to another aspect of the disclosure, there is provided a movable machine comprising: a main body; a rotatable support platform mounted on the main body to receive a payload; and a processor configured to implement the method as described above.

According to yet another aspect of the disclosure, there is provided a computer readable medium having a computer program stored thereon which, when executed by a processor, implements the method the method as described above.

### BRIEF DESCRIPTION OF THE DRAWINGS

In the drawings, similar/same reference signs throughout different views generally represent similar/same parts. Drawings are not necessarily on scale. Rather, emphasis is placed upon the illustration of the principles of the present invention. In these drawings:

FIG. 1 illustrates a schematic diagram of a movable machine with a payload placed thereon according to one embodiment of the present disclosure;

FIG. 2 illustrates a flowchart of a method for controlling the movable machine according to one embodiment of the present disclosure; and

FIG. 3 illustrates a schematic diagram of a movable machine with a payload moving along a curved path according to one embodiments of the present application.

### DETAILED DESCRIPTION OF THE EMBODIMENTS

Embodiments of the present disclosure will be described in more details with reference to the drawings. Although the drawings illustrate some embodiments of the present disclosure, it should be appreciated that the present disclosure can be implemented in various manners and should not be interpreted as being limited to the embodiments explained herein. On the contrary, the embodiments are provided to understand the present disclosure in a more thorough and complete way. It should be appreciated that drawings and embodiments of the present disclosure are only for exemplary purposes rather than restricting the protection scope of the present disclosure.

In the descriptions of the embodiments of the present disclosure, the term “includes” and its variants are to be read as open-ended terms that mean “includes, but is not limited to.” The term “based on” is to be read as “based at least in part on.” The terms “one embodiment” and “this embodiment” are to be read as “at least one embodiment.” The following text also can comprise other explicit and implicit definitions.

As mention above, movable machines such as autonomous mobile robots (AMRs) or autonomous guided vehicles (AGV) are widely utilized in logistics, transportation and robotic automations. It is important to improve the time efficiency and/or energy efficiency of the movable machines.

It is found that payloads are typically placed on a support platform of the AMR or AGV with a fixed pose relative to the main body of the AMR or AGV while the AMR or AGV is moving (e.g., along a curved path or turning). However, such a fixed pose of the payload with respect to the main body of the movable machine might lead to some disadvantages as listed below.
Payload often has a large rotational inertia, which implies a large torque to be used to rotate the payload while the main body is turning, causing a fair amount of energy to be consumed. For example, when the movable machine, e.g., the AMR, is moving along a curved path, if the payload is in a fixed pose relative to the main body, the driving system for the movable machine needs to overcome the rotational inertia of the payload, especially in the case of angular acceleration and deceleration.
As the fixed pose of the payload will require more motor output torque, higher motor current and more energy consumption is thus needed. Also, higher current spike might occur and then stress the controller for the movable machine and reduce the battery life.
More motor output torque might sometimes cause the slippage of the driving wheel, which will result in error of the odometer and as a consequence the navigation software will be fooled. In turn, the error will disrupt the stability of the payload, and the movable machine has to slow down.
In certain narrow corridors, there might be not enough space for a wide payload to pass or rotate along with the main body. If the payload is maintained in a fixed orientation with respect to the main body, it may prevent a smooth passage of the payload through the narrow corridors.

The present disclosure aims to provide a novel method for controlling the movable machine such that the orientation of the payload might be adjusted with respect to the main body. This method comprises: detecting an angular information of the main body of a movable machine; and inversely rotating a support platform of the movable machine with respect to the main body based on the detected angular information. Those skilled in the art will appreciate that with the inverse rotation of the support platform with respect to the main body, the output torque that is otherwise required by the movable machine might be reduced or minimized, as the support platform will not rotate with the main body and then there is no need to overcome the rotational inertia of the payload.

For better understanding of the present application, FIG. 1 illustrates a schematic diagram of a movable machine with a payload placed thereon according to one embodiment of the present disclosure.

As shown in FIG. 1, a movable machine 1 is provided comprising a main body 10 and a rotatable support platform 20. Just as an example, the movable machine 1 may be an autonomous mobile robot (AMR) or an autonomous guided vehicles (AGV). However, those skilled in the art will appreciate that the movable machine 1 being an AMR or AGV is not a limitation, any movable machine 1 including a main body 10 and a rotatable support platform 20 is also possible.

Typically, the main body 10 may comprise one or more wheels and associated motors (e.g., servo motors) (not depicted) coupled to said one or more wheels. In some embodiments, said one or more wheels may comprise one or more driven wheels and optionally one or more idler wheels, wherein the one or more driven wheels may be coupled and driven by the associated motors.

In some embodiments, the main body 10 itself may integrate a processor or controller (not shown), which may be used to control the components of the moving device (including e.g., motors, sensors, etc.). With such an integrated processor or controller, the main body 10 may then be controlled by itself to move or operate. In some embodiments, the main body 10 may be controlled by a remote processor or controller, which may be remotely connected with the main body in a wireless or wired manner.

Whether it is a processor or controller integrated with the main body 10 or a remote processor or controller, with the help of the processor or controller, the main body 10 may move as desired, e.g., along a planned path or to a specific position.

The rotatable support platform 20 is configured to support or carry a payload 30. Typically, in some embodiments, the support platform 20 may be provided on top of the main body 10, which may facilitate the transportation of the payload. However, this is not a limitation. In some embodiments, the support platform 20 being provided on any side of the main body 10, or even in the inner space of the main body, is also possible.

Typically, to further facilitate the transportation of the payload 30, in some embodiments, the rotatable support platform 20 may be provided with a motor (e.g., a servo motor) such that the support platform 20 may be lifted and/or rotated. The support platform 20 may be configured in any size or form as appropriate.

In some embodiments, all the motors as described above may be disposed inside the housing of the main body 10 to improve the appearance of the movable machine 1.

With the above configuration, the movable machine 1 may then carry the payload 30 with its rotatable support platform 20 and move along e.g., a planned path or to a specific position. The planned path 40 may be a linear or curved path.

In order to facilitate the control of the movable machine 1, various sensors may be further incorporated, including e.g., a rotary encoder for monitoring the motor shaft's speed and/or position, a weight sensor for monitoring the weight of the payload, an Inertial Measurement Unit (IMU) for monitoring the acceleration, orientation or angular rates of the main body, a radar sensor for navigation, etc.

As described above, the payload 30 are typically kept in a fixed pose relative to the main body 10, which might be problematic or disadvantageous. In order to overcome or alleviate the associated disadvantages, a method for controlling the moving machine is thus proposed.

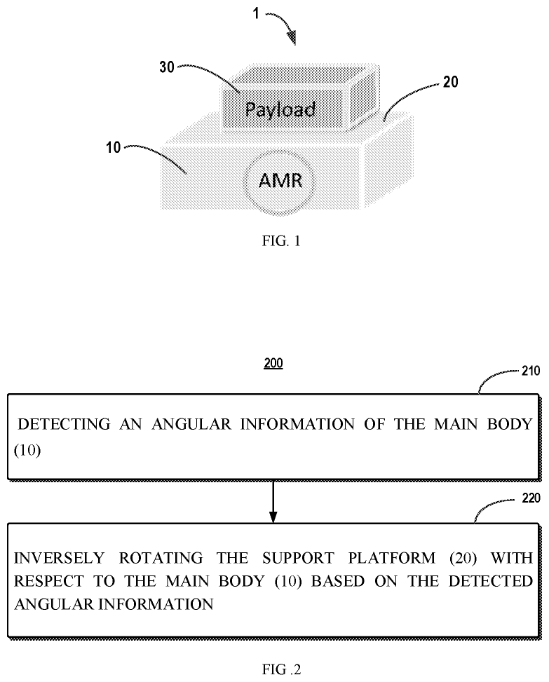

FIG. 2 illustrates a flowchart of the method for controlling the movable machine according to one embodiment of the present disclosure.

The method 200 may start at block 210, i.e., detecting an angular information of the main body.

Such an angular information is generally generated while the movable machine is moving along a curved path. Typically, the angular information of the main body may comprise at least an angular rate and a rotation direction.

In some embodiments, the detection of the angular information of the main body may be performed by an Inertial Measurement Unit (IMU) integrated on the main body.

In some embodiments, the detection of the angular information of the main body may be performed by e.g., measuring a rotation speed difference between two driving wheels arranged at the opposite sides of the main body; and calculating the angular information of the main body based on the measured rotation speed difference. Just as an example, the rotation speed for the driving wheel may be recorded by a rotary encoder attached to the associated motor for the driving wheel.

Once the angular information of the main body is detected, the method 200 may proceed to block 220, i.e., inversely rotating the support platform with respect to the main body based on the detected angular information. That means, the support platform as well as the payload placed thereon will be rotated with respect to the main body in a direction opposite to a rotation direction of the main body.

Typically, in some embodiments, the step of inversely rotating the support platform with respect to the main body may be performed in real time while the movable machine is moving. In this way, the orientation of the support platform as well as the payload may be changed as desired in real time.

In some embodiments, the inversely rotating the support platform with respect to the main body based on the detected angular information may comprise: inversely rotating the support platform with respect to the main body by a degree equal to a rotation degree of the main body derived from the detected angular information. Those skilled in the art would appreciate that the support platform will then be rotated to counteract the rotation of the main body with respect to a world coordinate system (e.g., a ground) where the movable machine is moving.

In particular, in some embodiments, the inversely rotating the support platform with respect to the main body may comprise: inversely rotating the support platform with respect to the main body during the moving of the movable machine such that an orientation of the support platform is kept constant with respect to a ground where the movable machine is moving. In this way, the need to overcome the rotational inertia of the payload may be minimized.

In some embodiments, the weight of the payload may be considered. In such embodiments, the inversely rotating the support platform with respect to the main body based on the detected angular information may comprise: measuring a weight of the payload; and inversely rotating the support platform with respect to the main body based on the detected angular information and the measured weight of the payload. In this way, the inversely rotation of the support platform may be implemented in a fast and accurate manner.

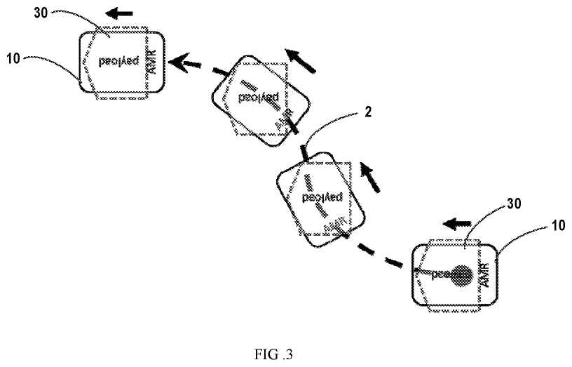

For better understanding of the above method, FIG. 3 illustrates a schematic diagram of a movable machine with a payload moving along a curved path according to one embodiments of the present application.

As shown in FIG. 3, while the movable machine 1 is moving along a curved path 2, the orientation of the support platform (not shown therein) and the associated payload 30 are always kept constant with respect to a ground or a world coordinate system.

Various embodiments have been described above mainly with respect to the method for controlling the movable machine. Through the above description, those skilled in the art would appreciate that there are a plenty of advantages associated with the method as described, which may be listed as below.
No extra energy will be needed to overcome the rotational inertia of the payload. The lower driving torque will require less current. Smaller driving mechanism (motor and reducer) will be used. Less energy consumed. Longer battery life will be achieved. Thus, less carbon emission.
The payload can be moved at higher pace and higher efficiency. Less moving machine (e.g., AMRs) will be needed for the same number of tasks.
More accurate navigation will be achieved on a curved path due to less slippage disturbing odometry.
In most real use cases, the center of gravity of the payload is not near the center of the main body of the moving machine (e.g., AMR). In such cases, the movable machine moving in a curved path might destabilize the payload and the movable machine itself. Especially when the center of gravity of the payload is at a higher position, the payload might even fall off the movable machine.
Extra flexibility in an environment will be allowed for the movable machine since less constraints to the payload dimensions on some occasions.

In addition to the above method for controlling the movable machine, those skilled in the art may further appreciate that the present disclosure may also relate to a movable machine, which may be configured to implement the method as described above. Also, the present disclosure may relate to a computer readable medium having a computer program stored thereon which, when executed by a processor or a controller, may implement the method as described above.

Although the above method is described with steps in sequence, it is noted that the sequence of the steps in the method may be changed, reordered, combined, omitted, modified, etc., as appropriate.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A method for controlling a movable machine comprising a main body and a rotatable support platform mounted on the main body to receive a payload, the method comprising:
detecting an angular information of the main body; and
inversely rotating the support platform with respect to the main body based on the detected angular information.

2. The method of claim 1, wherein the inversely rotating the support platform with respect to the main body based on the detected angular information comprises:
inversely rotating the support platform with respect to the main body by a degree equal to a rotation degree of the main body derived from the detected angular information.

3. The method of claim 1, wherein the inversely rotating the support platform with respect to the main body based on the detected angular information comprises:
inversely rotating the support platform with respect to the main body during the movement of the movable machine along a curved path such that an orientation of the support platform is kept constant with respect to a ground where the movable machine is moving.

4. The method of claim 1, wherein the step of inversely rotating the support platform with respect to the main body is performed in real time while the movable machine is moving along a path.

5. The method of claim 1, wherein the inversely rotating the support platform with respect to the main body based on the detected angular information comprises:
measuring a weight of the payload; and
inversely rotating the support platform with respect to the main body based on the detected angular information and the measured weight of the payload.

6. The method of claim 1, wherein the angular information of the main body comprises an angular rate and a rotation direction.

7. The method of claim 1, wherein the detection of the angular information of the main body is performed by an Inertial Measurement Unit integrated on the main body.

8. The method of claim 1, wherein the detection of the angular information of the main body is performed by:
measuring a rotation speed difference between two driving wheels arranged at the opposite sides of the main body; and
calculating the angular information of the main body based on the measured rotation speed difference.

9. The method of claim 1, wherein the movable machine comprises:
an autonomous mobile robot or an autonomous guided vehicles.

10. A movable machine comprising:
a main body;
a rotatable support platform mounted on the main body to receive a payload; and
a processor configured to implement the method of claim 1.

11. The movable machine of claim 10, wherein the movable machine is an autonomous mobile robot or an autonomous guided vehicles.

12. A non-transitory computer readable medium having a computer program stored thereon which, when executed by a processor, implements the method of claim 1.
